(19) United States
(12) Patent Application Publication
(10) Pub. No.: US 2008/0180058 A1
(43) Pub. Date: Jul. 31, 2008

(54) Plug-in battery charging booster for electric vehicle

(76) Inventors: Bijal Patel, Northville, MI (US); Philip M. Gonzales, Dearborn Heights, MI (US); Josephine S. Lee, Novi, MI (US); Viet Q. To, W. Bloomfield, MI (US); Joseph Stanek, Northville, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/699,913

(22) Filed: Jan. 30, 2007

(51) Int. Cl. H02J 7/04; B60L 1/00

(52) U.S. Cl. 320/109; 307/10.1

(57) ABSTRACT

A system for charging an electric storage battery in an electric vehicle includes a first converter electrically connectable to a first source of AC electric power, for converting AC from the first power source to a first DC output, a second converter electrically connectable to a second source of AC electric power that is out of phase relative to the first AC power source, for converting AC from the second power source to a second DC output, and a regulator electrically coupled to the first DC output, the second DC output and the battery, for producing and charging the battery with a third DC output having a higher voltage than the voltage of the first and the second DC outputs.

### BACKGROUND OF THE INVENTION

1. Field of the Invention

The preferred embodiment relates generally to a method and apparatus for charging a battery of a motor vehicle driven by electric power, and more particularly to a high voltage traction battery.

2. Description of the Prior Art

A hybrid electric vehicle is equipped with an electric machine, such as a starter-generator or traction motor, an electric storage battery for supplying electric power to the traction motor, a brake regeneration system including a converter for recovering kinetic energy of the vehicle as it is slowed by the wheel brakes and converting that energy to electric current stored in the storage battery, and a second power source such as an internal combustion engine (ICE) or fuel cell for driving the motor and/or the vehicle wheels and generating electric current that is stored in the battery.

An external power source such as an electric utility power grid may be used to charge the battery while the vehicle is parked. However, in homes and most consumer locations the magnitude of electric current is limited by conventional circuit breakers to about 15 amps. The length of the period to fully charge a traction battery is about &8 hours, which is unacceptably too long for most consumer usage. There is, therefore, a need to reduce the length of the charging period when an electric utility power grid is the power source for the charge.

Electric vehicles are provided with systems for heating and cooling the passenger compartment upon drawing electric power from the traction battery. There is a need to preheat or pre-cool automatically the vehicle before the operator enters the vehicle while maintaining the traction battery fully charged for use when the vehicle is driven by the operator. Preferably the operator would schedule the period for charging the battery during off-peak hours, i.e., while adequate power capacity is available from the electric utility and electric power rates are lower than when power demand is higher.

Currently vehicles equipped with fuel cell systems present unique problems associated with low temperature operation including limited vehicle performance during a long fuel cell startup period, limited battery power availability, and a cold passenger compartment. Unlike a vehicle equipped with an internal combustion engine, a vehicle equipped with a fuel cell system is subject to a lengthy warm-up period in cold temperature operation which limits vehicle drive-away performance. Fuel cell systems provided limited ability to heat the passenger compartment heating using coolant heat because the coolant temperature remains low for a period following vehicle start-up.

There is a need for an onboard system that will charge a high voltage battery for use in preheating a fuel cell system, such as the stack, and vehicle's passenger compartment.

### SUMMARY OF THE INVENTION

A system for accomplishing these advantages and charging an electric storage battery in an electric vehicle includes a first converter electrically connectable to a first source of AC electric power, for converting AC from the first power source to a first DC output, a second converter electrically connectable to a second source of AC electric power that is out of phase relative to the first AC power source, for converting AC from the second power source to a second DC output, and a regulator electrically coupled to the first DC output, the second DC output and the battery, for producing and charging the battery with a third DC output having a higher voltage than the voltage of the first and the second DC outputs.

The battery charging system, which is located onboard the vehicle, can use one or two standard 110 Vac outlets connected to a 220 Vac power source, such as that supplied from an electric utility power grid, and two dedicated AC-DC converters. The system detects if the two 110 Vac power sources are at the same phase, and balances or equalizes power usage from two power sources.

The system employs a slow power ramp-up to prevent tripping a circuit breaker in power supply circuit. The system doubles the charging capacity and reduces the length of the charge period by about one-half.

The system and method pre-heat and/or pre-cool the vehicle passenger compartment at the end of battery charge cycle, and provide an adjustable delay time feature, which optimizes power usage by scheduling the battery charge period to off-peak periods when utility rates are lower than peak period rates.

This unique feature could help bring up the temperature of the fuel cell system, battery, and passenger compartment to help reduce unique limitations of cold fuel cell vehicle operation. While preheat the passenger compartment, the system uses a water-ethylene glycol (WEG) heater and other components to condition the vehicle optimally and efficiently. Protections are provided by the system to prevent and limit the amount of power used.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

These and other advantages will become readily apparent to those skilled in the art from the following detailed description of a preferred embodiment when considered in the light of the accompanying drawings in which:

FIG. 1 is a diagram showing components of the vehicle powertrain, and accessories, and a charging system in a hybrid electric vehicle;

FIG. 2 is a schematic diagram of a charging booster system for a hybrid electric vehicle;

FIG. 3 is a schematic diagram of the charging booster system of FIG. 2 showing circuit details of AC to DC converters and a high voltage buck regulator; and

FIG. 4 is diagram of steps for operating the system of FIG. 2.

### DESCRIPTION OF THE PREFERRED EMBODIMENT

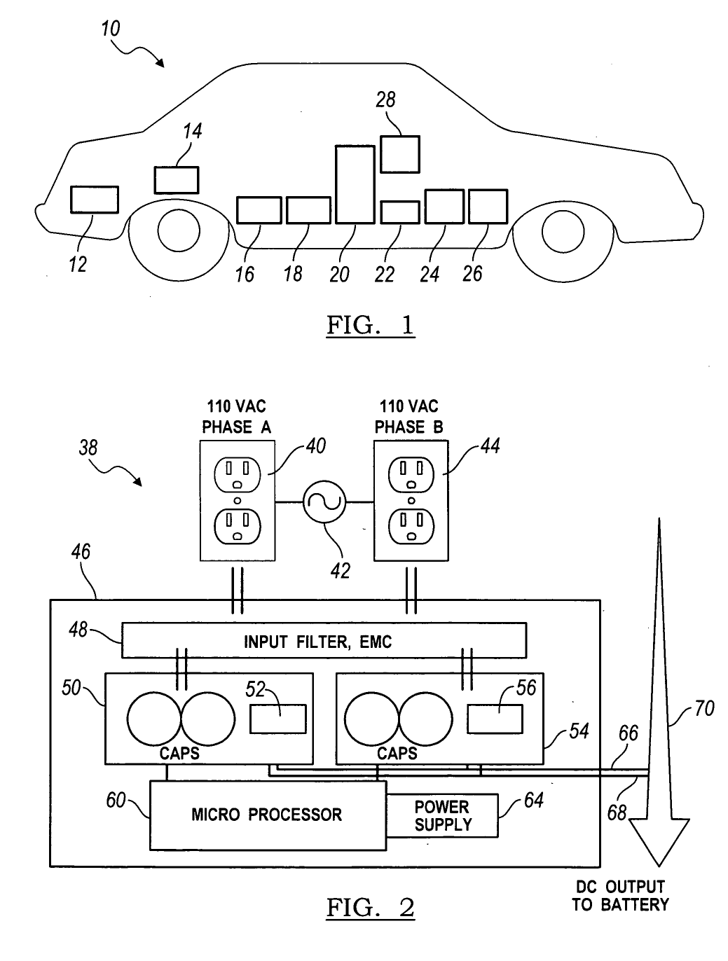

Referring to FIG. 1, a hybrid electric vehicle 10 is equipped with an electric machine 12, such as a starter-generator or traction motor; a high voltage (about 240-285V) electric storage battery 14 for supplying electric power to the traction motor 12; a low voltage (about 12V) service battery 16 for supplying power to vehicle lights, horn, and other vehicle accessories; a brake regeneration system 18 including a converter for recovering kinetic energy of the vehicle while being slowed by the wheel brakes and converting that energy to electric current stored in the battery 14; a second power source 20 such as an ICE or fuel cell for driving the motor and/or the vehicle wheels, and generating electric current for storage in battery 14; a microprocessor 22 for controlling the powertrain and other vehicle systems; an air conditioning compressor 24 driven by an electric motor, an electric heater 26 supplied with power from battery 14; and a WEG heater 28 supplied with power from battery 14.

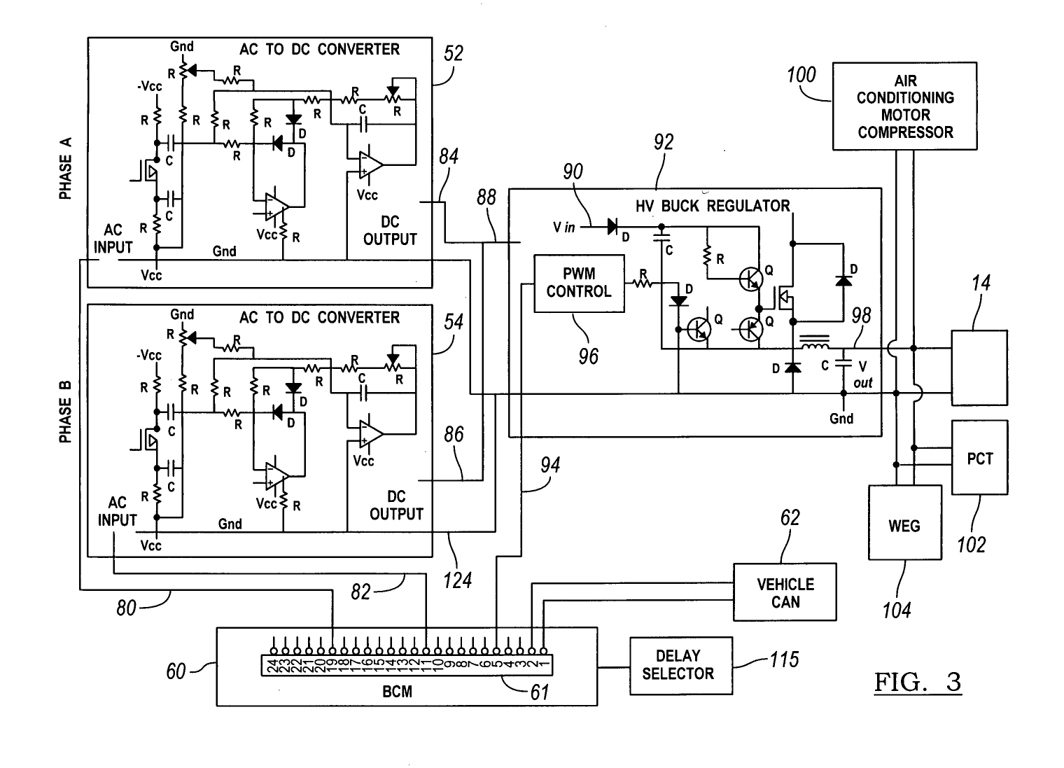

Referring now to FIGS. 2 and 3, the charging booster system 38 includes a first wall socket 40 supplied with 110 Vac phase A electric power from a power source 42, such as a public electric utility power grid power, and a second wall socket 44 supplied with 110 Vac phase B from the power source 42, the voltages being preferable 180 degrees out of phase. The 220 Vac power supply normally provided by the electric utility 42 may be split to provide two 110 Vac out-of-phase voltage sources. The two 110 Vac voltage sources 40, 44 are generally located at a fixed location outboard of the vehicle 10.

Located onboard the electric vehicle 10 is an inverter/voltage booster system 46. An electromagnetic compatibility (EMC) input filter 48, coupled to the wall sockets 40, 44, ensures that neither the utility grid 42 nor other equipment susceptible to electromagnetic radiation, such as a garage door opener, is adversely affected by electromagnetic effects produced by system 46.

The EMC input filter 48 is coupled to a first inverter power board 50, which is a printed circuit board containing a first electronic inverter circuit 52. Similarly, the EMC input filter 48 is coupled to a second inverter power board 54, which is a printed circuit board containing a second electronic inverter circuit 56. A battery control module 60 includes a microprocessor 61 and vehicle CAN nodes, through which the microprocessor communicates via a vehicle CAN 62 with boards 50, 54, vehicle powertrain controls, vehicle electric controls, and vehicle power supply input 64. Lines 66, 68 electrically connect boards 50, 54 to a DC power output 70, through which power is provided to the vehicle electric system.

The phase A and phase B 110 Vac inputs are carried on lines 80, 82 to the inputs of the first and second electronic inverter circuits 52, 54, respectively. The outputs 84, 86 of each circuit 52, 54 is 110 Vdc, coupled at line 88 and carried to the input 90 of a high voltage buck regulator circuit 92. Battery control module 60 supplies a low power PWM control signal on line 94 to a PWM control 96 located in circuit 90. When the vehicle inverter 46 is supplied by phase A and phase B power at 110 Vac, the output voltage 98 produced by circuit 90 is about 285 Vdc.

As FIG. 3 illustrates, output voltage 98 is connected to the terminals of the high voltage traction battery 14; an air conditioning motor/compressor set 100 for pre-cooling the passenger compartment of the vehicle 10 during hot weather preparatory to a vehicle operator entering the vehicle; the positive temperature coefficient (PTC) element 102 normally located in hybrid electric vehicles for preheating the passenger compartment during cold weather preparatory to a vehicle operator entering the vehicle; and the fluid pump and heating element of a WEG heater system 104 for preheating the passenger compartment during cold weather preparatory to a vehicle operator entering a vehicle equipped with a fuel cell power source.

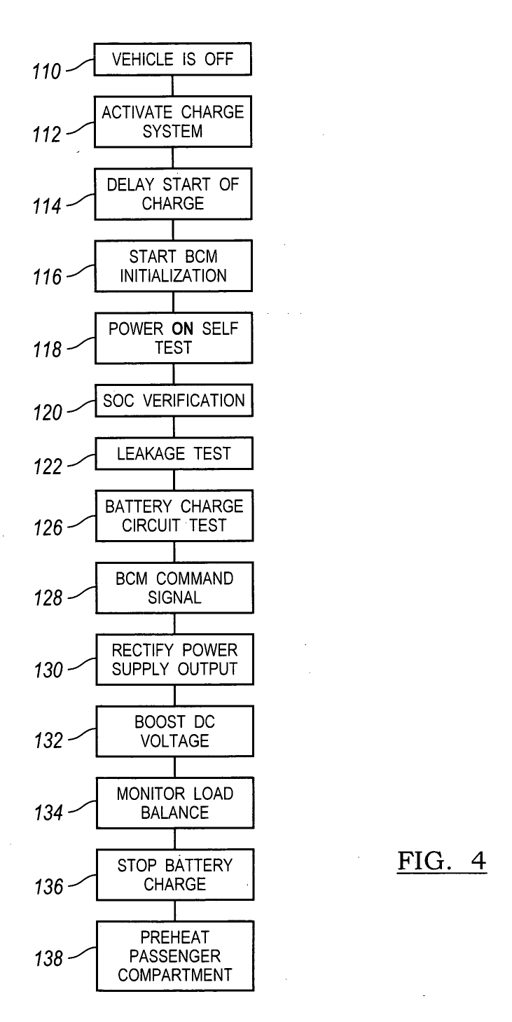

FIG. 4 illustrates the steps of a method for controlling the battery charge system 38. At step 110 the vehicle ignition is off, i.e., it is in the key-off state. At step 112 the charge system 38 is activated when the vehicle receives a 120 Vac signal from one or both of the power circuits 40, 44.

At step 114, the vehicle operator can select a delay period, by activating a delay timer selector 115 located onboard the vehicle on the instrument panel, which selector is coupled to a count down timer in microprocessor 61. The delay period must expire before the battery charge period begins. Preferably, the delay period will cause the battery 14 to be charged while utility power rates are at off-peak rates.

At step 116, the BCM 60 starts its initialization, which includes the steps of: performing a power-on self test 118; a battery state of charge (SOC) verification 120; a leakage test 122 to determine and produce a signal indicating whether the high voltage traction battery voltage is connected to the 120 Vac power supply circuits 40, 44 or to the vehicle chassis ground 124; a battery charge circuit test 126, which checks whether the two converters 52, 54 are connected to the same circuit 40, 44 by supplying a frequency pulse test on the Phase A converter circuit 52 and sensing for a corresponding pulse on the Phase B converter circuit 54. At step 128, the BCM 60 produces a command signal that causes a slow power ramp-up to prevent tripping a circuit breaker in the power supply circuit, thereby avoiding a brown-out condition. At step 130, the 120 Vac power supply output is rectified in circuits 52 and/or 54 to 120 Vdc. At step 132, the 120 Vdc is boosted in circuit 92 to 280 Vdc. And at step 134, the BCM 60 monitors load balancing between the two input circuits 40, 44 to avoid a substantial difference in impedance between the two phases A and B.

At step 136, battery charging is terminated when the SOC of traction battery 14 reaches a predetermined magnitude.

At step 138, the passenger compartment is preheated using the PTC 102 or WEG 104, or the passenger compartment is cooled using the motor and air conditioning compressor set 100.

In accordance with the provisions of the patent statutes, the preferred embodiment has been described. However, it should be noted that the alternate embodiments can be practiced otherwise than as specifically illustrated and described.

What is claimed is:

1. A system for charging an electric storage battery in an electric vehicle comprising:
a first converter electrically connectable to a first source of AC electric power, for converting AC from the first power source to a first DC output;
a second converter electrically connectable to a second source of AC electric power that is out of phase relative to the first AC power source, for converting AC from the second power source to a second DC output; and
a regulator electrically coupled to the first DC output, the second DC output and the battery, for producing and charging the battery with a third DC output having a higher voltage than the voltage of the first and the second DC outputs.

2. The system of claim 1 wherein the first converter and second converter and regulator are located onboard the vehicle.

3. The system of claim 1 further comprising:
a compressor for an air conditioning system located in the vehicle; and
a motor driveably connected to the compressor and electrically coupled to the battery.

4. The system of claim 1 further comprising:
an electric heating element located in the vehicle and electrically coupled to the battery.

5. The system of claim 1 further comprising:
a heating system containing a fluid and located in the vehicle; and
a motor driveably connected to a pump for circulating the fluid through the heating system.

6. A system for charging an electric storage battery in an electric vehicle comprising:
a first source of AC electric power;
a second source of AC electric power that is out of phase relative to the first source;
a first converter electrically connected to the first source of AC electric power for converting AC from the first source to a first DC output;
a second converter electrically connected to the second source of AC electric power for converting AC from the second power source to a second DC output;
a regulator electrically coupled to the first DC output, the second DC output and the battery for producing and charging the battery with a third DC output having a higher voltage than the voltage of the first and the second DC outputs; and
a controller for applying a pulse on the first converter and determining whether a corresponding pulse is present on the second converter, thereby determining whether the first and second power sources are connected to the same converter.

7. The system of claim 6 further comprising a selector controlled manually for indicating a desired delay in performing a battery charge, and wherein the controller further schedules a period during which the battery is charged by the system in response to input to the selector.

8. The system of claim 6 wherein the controller further causes the time rate of power flow to the battery from the charging system to increase at a rate that is sufficiently slow to avoid overloading the power supply and opening a circuit breaker in the power supply.

9. The system of claim 6 wherein the controller further monitors the magnitude of a difference in a load on the first power source and a load on the second power source.

10. The system of claim 6 wherein the controller further monitors the state of charge of the battery, and terminates battery charging when said state of charge reaches a predetermined magnitude.

11. The system of claim 6 further comprising:
a compressor for an air conditioning system located in the vehicle; and
a motor driveably connected to the compressor and electrically coupled to the battery.

12. The system of claim 6 further comprising:
an electric heating element located in the vehicle and electrically coupled to the battery.

13. The system of claim 6 further comprising:
a heating system containing a fluid and located in the vehicle; and
a motor driveably connected to a pump for circulating the fluid through the heating system.

14. In a system for charging an electric storage battery in a electric vehicle that includes a first converter electrically connectable to a first source of AC electric power, a second converter electrically connectable to a second source of AC electric power that is out of phase relative to the first AC power source, and a regulator electrically coupled to the first DC output and the second DC output, a method comprising the steps of:
using the regulator to produce a third DC output having a higher voltage than the voltage of the first and the second DC outputs;
coupling the battery to the third DC output; and
using the third DC output to increase the state of charge of the battery.

15. The method of claim 14, further comprising the steps of:
using the battery to drive a motor driveably connected to an air conditioning in a system for controlling the temperature of ambient air in a passenger compartment of the vehicle.

16. The method of claim 14, further comprising the steps of:
using the battery to heat an electric heating element located in a passenger compartment of the vehicle.

17. The method of claim 14, further comprising the steps of:
using the battery to drive a pump that circulates fluid in a passenger compartment of the vehicle.
